(19) United States
(12) Patent Application Publication
(10) Pub. No.: US 2017/0091707 A1
(43) Pub. Date: Mar. 30, 2017

(54) SMART DROP BOXES FOR AUTONOMOUS DEVICES

(71) Applicant: International Business Machines Corporation, Armonk, NY (US)

(72) Inventors: Ben Z. Akselrod, Givat Shmuel (IL); Anthony Di Loreto, Markham (CA); Steve McDuff, Markham (CA); Kyle D. Robeson, North York (CA)

(21) Appl. No.: 14/868,767

(22) Filed: Sep. 29, 2015

(51) Int. Cl. G06Q 10/08

(52) U.S. Cl. CPC G06Q 10/0833; G06Q 10/0836

(57) ABSTRACT

A method for using a smart drop box. The method includes an autonomous device delivering, or picking up, a package to a smart drop box, wherein the smart drop box is equipped to handle one or more packages for different parties, each in a respective secured space within the smart drop box. Upon approaching the smart drop box, the autonomous device transmits a secure identification including an indication of a package for delivery. The smart drop box then determines whether a current weight of the package is substantially equal to a weight of the package when initially shipped. If the package weight is verified, the autonomous device is allowed to place the package in the smart drop box where the package is secured. The smart drop box then notifies an intended recipient that the package is awaiting pickup and includes a security identifier needed to open the smart drop box.

### BACKGROUND

The present invention relates generally to the field of autonomous devices, and more particularly to package delivery to smart drop boxes using autonomous devices.

A community mailbox is a group of mail boxes, typically in the same enclosure, set up at outdoor locations to serve multiple residences from a single location.

Drones, also referred to as autonomous devices, are known. Generally speaking, an autonomous device is autonomous (or semi-autonomous), and is usually an electro-mechanical machine that is guided by a computer program and/or electronic circuitry. Autonomous devices may range in form from humanoids, medical operating robots, patient assist robots, therapy robots, collectively programmed swarm robots, unmanned aerial vehicles (UAVs), and microscopic nano robots.

### SUMMARY

Embodiments of the present invention disclose a method, computer program product, and system for using a smart drop box. The method includes determining whether an autonomous device is to perform one of a delivery to a smart drop box or a pickup from the smart drop box, wherein the smart drop box is equipped to handle one or more packages for different parties, each in a respective secured space within the smart drop box. The smart drop box receives a secure identification from the autonomous device upon approach to the smart drop box, including an indication of a first package for delivery. The smart drop box then determines whether a current weight of the first package is substantially equal to a weight of the first package when initially shipped. In response to determining that the current weight of the first package is substantially equal to the weight of the first package when initially shipped, the smart drop box allows the first package to be transferred to the smart drop box, wherein the first package is secured. The smart drop box then notifies a first intended recipient that the first package is awaiting pickup, wherein the notifying further comprises a security identifier needed to open the smart drop box.

### BRIEF DESCRIPTION OF THE DRAWINGS

FIG. 1 is a functional block diagram illustrating a package delivery environment, in an embodiment in accordance with the present invention.

FIG. 2 is a flowchart depicting operational steps of drop box software, on a smart drop box within the package delivery environment of FIG. 1, for receiving a package from an autonomous device, in an embodiment in accordance with the present invention.

FIG. 3 is a flowchart depicting operational steps of drop box software, on a smart drop box within the package delivery environment of FIG. 1, for receiving a package from a customer to be picked up by an autonomous device, in an embodiment in accordance with the present invention.

FIG. 4 is a flowchart depicting operational steps of an autonomous device, within the package delivery environment of FIG. 1, for depositing a package in a smart drop box, in an embodiment in accordance with the present invention.

FIG. 5 is a flowchart depicting operational steps of an autonomous device, within the package delivery environment of FIG. 1, for picking up a package from a smart drop box, in an embodiment in accordance with the present invention.

FIG. 6 depicts a block diagram of components of the smart drop box executing the drop box software, in an embodiment in accordance with the present invention.

### DETAILED DESCRIPTION

Embodiments in accordance with the present invention recognize that when autonomous devices are used to deliver packages to customers, it may not always be possible to deliver directly to a customer's home. For example, the customer may live in an apartment building, or the customer's home may have dense foliage preventing the autonomous device from making the delivery. When packages require a signature/proof of delivery, it is even harder to deliver as customers may not be available to provide a signature. It would be costly to manage a fleet of autonomous devices that, upon failure to deliver a package, must return to the shipping facility and try again.

When autonomous devices are faced with the inability to deliver packages directly to customers, smart drop boxes may be used. Similar to community mail boxes, these drop boxes are situated in public areas that would cover a range of customers. The individual drop boxes are not associated to a specific party, however, but are instead general boxes that are temporarily assigned and secured for a particular party.

The smart drop box is built to work/communicate with autonomous devices, including security measures and methods to verify the package was deposited successfully. These include cameras, scales, radio frequency identification (RFID), near field communications (NFC), and/or Bluetooth, and/or ad hoc networks. RFID is the wireless use of electromagnetic fields to transfer data, for the purposes of automatically identifying and tracking tags, containing electronically stored information, attached to objects. NFC is the set of protocols that enables electronic devices to establish radio communication with each other by touching the devices together or bringing them into proximity to a distance of typically 10 cm or less. Bluetooth is a wireless technology standard for exchanging data over short distances. A wireless ad hoc network (WANET) is a decentralized type of wireless network. An ad hoc network does not rely on a pre-existing infrastructure, such as routers in wired networks or access points in managed (infrastructure) wireless networks. Instead, each node participates in routing by forwarding data for other nodes, so the determination of which nodes forward data is made dynamically on the basis of network connectivity. The smart drop box also supports the reverse function, where packages are deposited by customers (e.g. returns), and autonomous devices will pick up and deliver the packages to another destination such as the original supplier.

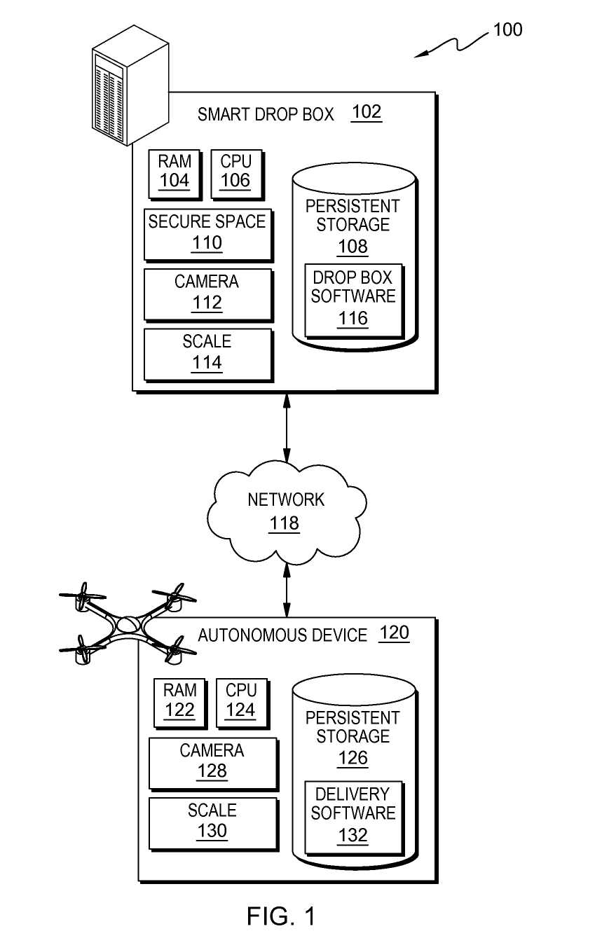

Embodiments in accordance with the present invention will now be described in detail with reference to the Figures. FIG. 1 is a functional block diagram, generally designated 100, illustrating a package delivery environment, in an embodiment in accordance with the present invention.

Package delivery environment 100 includes smart drop box 102, also referred to as drop box 102, and autonomous device 120. Drop box 102 includes random access memory (RAM) 104, central processing unit (CPU) 106, persistent storage 108, secure space 110, camera 112, and scale 114. Drop box 102 may include a Web server, or any other electronic device or computing system, capable of processing program instructions and receiving and sending data. In some embodiments, drop box 102 may include a laptop computer, a tablet computer, a netbook computer, a personal computer (PC), a desktop computer, a personal digital assistant (PDA), a smart phone, or any programmable electronic device capable of communicating over a data connection to network 118. In other embodiments, drop box 102 may represent server computing systems utilizing multiple computers as a server system, such as in a distributed computing environment. In general, drop box 102 is representative of any electronic devices or combinations of electronic devices capable of executing machine-readable program instructions and communicating with autonomous device 120 via network 118 and with various components and devices within package delivery environment 100.

Drop box 102 includes persistent storage 108. Persistent storage 108 may, for example, be a hard disk drive. Alternatively, or in addition to a magnetic hard disk drive, persistent storage 108 may include a solid state hard drive, a semiconductor storage device, read-only memory (ROM), erasable programmable read-only memory (EPROM), flash memory, or any other computer-readable storage medium that is capable of storing program instructions or digital information. Drop box software 116 is stored in persistent storage 108, which also includes operating system software, as well as software that enables drop box 102 to communicate with autonomous device 120, as well as other computing devices over a data connection on network 118. Drop box software 116 provides the ability for drop box 102 to communicate with nearby autonomous devices, such as autonomous device 120, via NFC, Bluetooth, ad hoc Wifi, or other communication methods. Drop box software 116 also provides a way by which autonomous device 120 can confirm its identity by exchanging and verifying encryption keys signed by the owning facility's certificate authority (CA) certificate. In cryptography, a CA is an entity that issues digital certificates. A digital certificate certifies the ownership of a public key by the named subject of the certificate. This allows relying parties to rely upon signatures or on assertions made by the private key that corresponds to the certified public key. In this model of trust relationships, a CA is a trusted third party that is trusted both by the owner of the certificate and by the party relying upon the certificate.

Drop box software 116 is also used to generate passcodes, also referred to as passwords or security identifiers, used to open secure space 110 by a customer or autonomous device 120 to retrieve a package.

Drop box 102 also includes secure space 110. Secure space 110 is used by drop box 102 to provide a secure temporary storage for packages that are placed in the drop box by customers, retailers, or autonomous devices, for example. In one example embodiment, drop box 102 and secure space 110 may incorporate weather proofing technology to protect packages from moisture, wind, and exposure to heat from sunlight. In another example embodiment, drop box 102 and secure space 110 may utilize materials to prevent scanning, such as computer tomography (CT) scanning, of the packages by someone (or something) outside drop box 102. A CT scan, also referred to as X-ray computed tomography (X-ray CT), or computerized axial tomography scan (CAT scan), makes use of computer-processed combinations of many X-ray images taken from different angles to produce cross-sectional (tomographic) images (virtual ‘slices’) of specific areas of a scanned object, allowing the user to see inside the object without cutting or opening the object.

Camera 112 is also included in drop box 102 and is used to record transactions—for example, when autonomous device 120 places the package in secure space 110. Camera 112 is also used by drop box software 116 to monitor the area around drop box 102 for suspicious activity. In one example embodiment, after monitoring an unauthorized person trying to forcefully open secure space 110, drop box software 116 may notify the authorities and inform the customer of the situation so that the customer may avoid any harm. In another example embodiment, camera 112 may be used by autonomous device 120, using a wireless connection, to aid as a guidance system when picking up packages from, or delivering packages to, drop box 102.

Drop box 102 also includes scale 114 to weigh packages when they are deposited into drop box 102 to measure the weight of the package to determine shipping costs or to compare the weight to the recorded weight autonomous device 120 measured at pickup time to determine if the weights are substantially equal. The measured weights may have a predefined delta based on the material used to enclose the package. Therefore, if the package was to encounter precipitation while autonomous device 120 is delivering it to drop box 102, the measured weight at the arrival time at drop box 102 may be slightly higher than the measured weight indicated by the distributor. In this case, drop box software 116 will account for the additional weight. Scale 114 may also be used to determine if the package is too heavy for autonomous device 120. For example, a customer may deliver a package to drop box 102 for pickup by autonomous device 120. When the package is inserted into drop box 102, scale 114 may determine the package is too heavy for autonomous device 120 and may notify the delivery company to dispatch a vehicle to pick up the package.

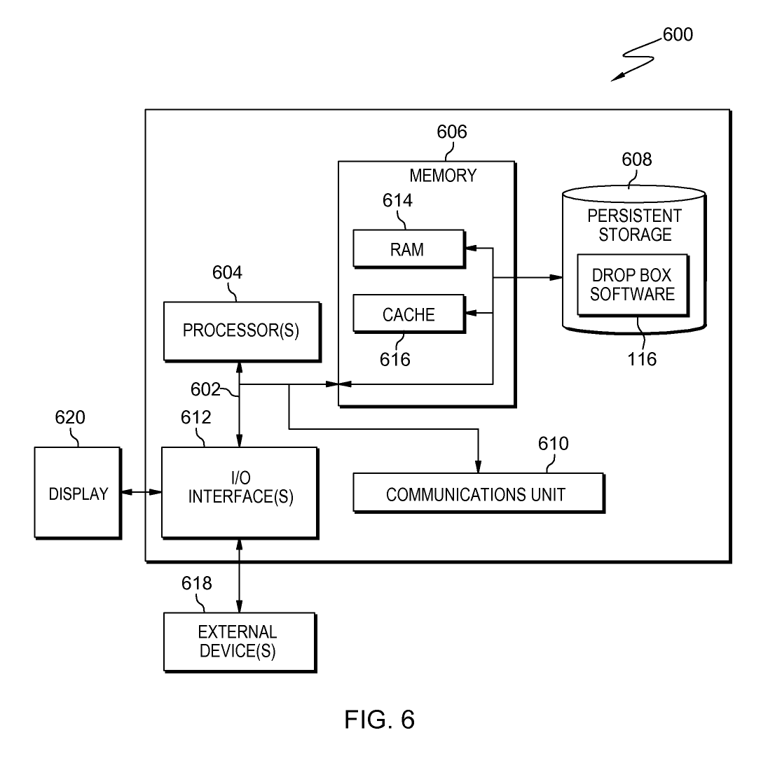

Smart drop box 102 may include internal and external hardware components, as depicted and described in further detail with respect to FIG. 6.

In FIG. 1, network 118 is shown as the interconnecting fabric between data protection drop box 102 and autonomous device 120. In practice, network 118 may be any viable data transport network. Network 118 can be, for example, a local area network (LAN), a wide area network (WAN) such as the Internet, or a combination of the two, and can include wired, wireless, or fiber optic connections. In general, network 118 can be any combination of connections and protocols that will support communications between data protection drop box 102 and autonomous device 120 in accordance with an embodiment of the invention. In other example embodiments, drop box 102 may use NFC, and/or Bluetooth, and/or ad hoc Wifi to communicate with autonomous device 120 and other devices (not shown) within package delivery environment 100.

Package delivery environment 100 also includes autonomous device 120. Autonomous device 120 contains RAM 122, CPU 124, persistent storage 126, camera 128, and scale 130. In one example embodiment, autonomous device 120, may include a microcontroller or other application-specific integrated circuit (ASIC) that integrates RAM 122, CPU 124, and at least a portion of persistent storage 126 to improve miniaturization within autonomous device 120. In some embodiments, autonomous device 120 may be an unmanned aerial vehicle or a mechanical robot capable of processing program instructions and receiving and sending data to pick up packages from, or deliver packages to, drop box 102. In other embodiments, autonomous device 120 may represent server computing systems utilizing multiple autonomous devices (e.g., a collectively programmed swarm) as a server system, such as in a distributed computing environment. In general, autonomous device 120 is representative of any electronic devices or combinations of electronic devices capable of executing machine-readable program instructions and communicating with drop box 102, customers, and retailers via network 118 and with various components and devices within package delivery environment 100.

Autonomous device 120 contains persistent storage 126. Persistent storage 126 may, for example, be a hard disk drive. Alternatively, or in addition to a magnetic hard disk drive, persistent storage 126 may include a solid state hard drive, a semiconductor storage device, read-only memory (ROM), erasable programmable read-only memory (EPROM), flash memory, or any other computer-readable storage medium that is capable of storing program instructions or digital information. Delivery software 132 is stored in persistent storage 126, which also contains operating system software, as well as software that enables autonomous device 120 to communicate with drop box 102, as well as other computing devices over a data connection on network 118. In other example embodiments, delivery software 132 may be contained at a central location, such as the retailer distribution center, and operate and communicate through a plurality of drop boxes in one or more designated drop box locations. All communications with autonomous devices are then relayed from the plurality of drop boxes to the retailer distribution center.

Delivery software is used by autonomous device 120 to identify and authenticate with drop box 102, record package transactions and verify packages using camera 128 and scale 130, and storing and relaying passcodes received from drop box 102 to customers and retailers. For example, when delivering a package to drop box 102, delivery software 132 will authenticate with drop box software 116. Upon successfully authenticating, autonomous device 120 may activate camera 128 to place the package in secure space 110. Another example would be when autonomous device 120 is picking up a package from drop box 102. Delivery software 132 will authenticate with drop box software 116 and upon successfully authenticating, autonomous device 120 may activate scale 130 to verify the shipping weight of the package to compare with the recorded weight when the package was placed in secure space 110. In other example embodiments, delivery software 132 may be used by drop box software 116 when suspicious activity is detected to provide greater detail and coverage of the situation. In other example embodiments, delivery software may include a law enforcement override to allow police officers to temporarily use autonomous device 120 and camera 128 to aid in law enforcement activities.

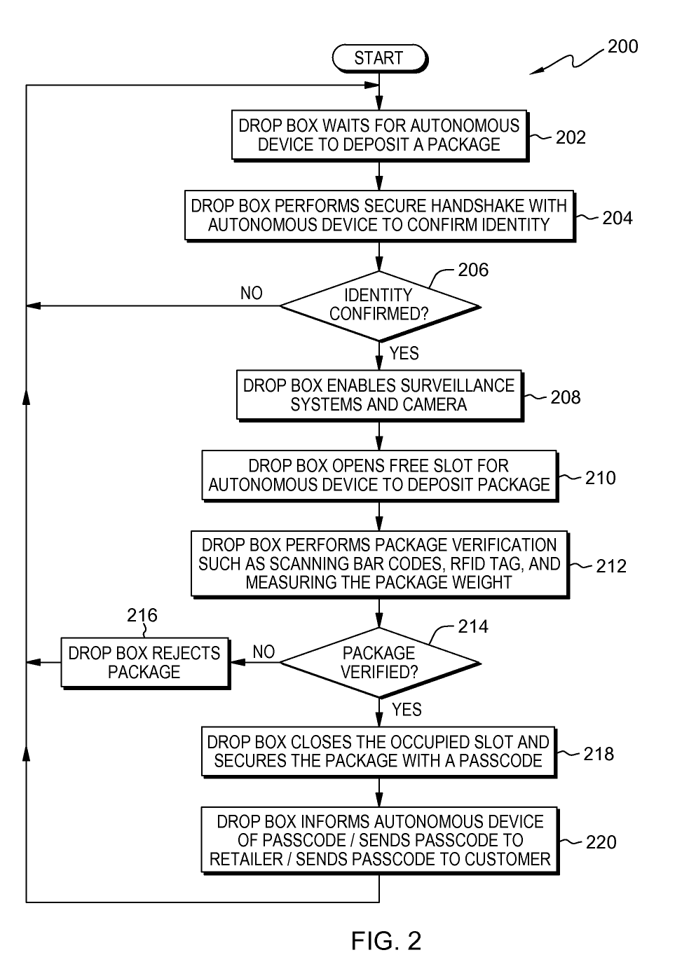

FIG. 2 is a flowchart, generally designated 200, depicting operational steps of drop box software, on a smart drop box within the package delivery environment of FIG. 1, for receiving a package from an autonomous device, in an embodiment in accordance with the present invention. In an example embodiment, a package is brought to drop box 102 by autonomous device 120 because a customer is not home to accept delivery, or the retailer or distribution center schedules the package to be delivered to drop box 102. Drop box 102 waits for autonomous device 120 to deposit a package as depicted in step 202. Drop box 102 may use camera 112 to monitor the area around drop box 102 for suspicious activity while waiting for a package to be delivered. For example, a customer has a scheduled pickup time for a package at 5:30 PM, and drop box 102 detects a person hiding in bushes nearby, drop box 102 may notify the customer and the authorities via text message that the area may not be safe. In other example embodiments, drop box 102 may include motion and heat sensor devices that will activate camera 112 when someone is within a certain distance from drop box 102.

In step 204, drop box 102 performs a secure handshake with autonomous device 120 to confirm identity. Upon arriving at drop box 102, autonomous device 120 identifies itself by exchanging and verifying encryption keys signed by the owning facility's CA certificate with drop box 102. Some authentication methods that may be used include: (i) Kerberos, (ii) Transport Layer Security (TLS) and/or Secure Sockets Layer (SSL), (iii) Password Authentication Protocol (PAP) and/or Shiva Password Authentication Protocol (SPAP), (iv) Challenge-Handshake Authentication Protocol (CHAP), (v) Extensible Authentication Protocol (EAP), and (vi) Remote Authentication Dial-In User Service (RADIUS). Kerberos is a client-server computer network authentication protocol that works on the basis of ‘tickets’ to allow nodes communicating over a non-secure network to prove their identity to one another in a secure manner. With Kerberos, both the client (i.e., autonomous device 120) and the server (i.e., drop box 102) verify each other's identity and the Kerberos protocol messages are protected against eavesdropping and replay attacks. TLS and SSL, both of which are frequently referred to as ‘SSL’, are cryptographic protocols designed to provide communications security over a computer network using asymmetric cryptography to authenticate the target node, and to negotiate a symmetric session key that is used to encrypt data transmitted between the parties. PAP and SPAP are authentication protocols that use a password to authenticate the user. SPAP uses an encrypted password authentication protocol. CHAP authenticates a user or network host to an authenticating entity through the use of an incrementally changing identifier and of a variable challenge-value. EAP is an authentication framework frequently used in wireless networks and point-to-point connections. RADIUS is a client/server protocol that runs in the application layer, using User Datagram Protocol (UDP) as transport, to provide a centralized authentication, authorization, and accounting management for devices wanting to connect and use a network service.

In decision step 206, drop box 102 determines if the identity of autonomous device 120 was confirmed. If the identity of autonomous device 120 was not confirmed (“No” branch decision 206), drop box 102 denies access by autonomous device 120 and repeats step 202. An example of failing authentication would be an improper CA certificate from a rouge autonomous device trying to gain access to drop box 102. In this situation autonomous device 120 is rejected and drop box 102 may notify the retailer distribution center and/or the authorities. If the identity of autonomous device 120 is confirmed (“Yes” branch decision 206), drop box 102 enables surveillance systems and camera 112 as depicted in step 208. An example of the surveillance systems would be activating motion and heat detection devices (not shown) and one or more camera 112's to ensure the area is safe before attempting the package transaction.

Drop box 102 opens a free slot in secure space 110 for autonomous device 120 to deposit package in, as depicted in step 210. Secure space 110 may be large enough to hold more than one package for a particular customer and incorporate weather proofing technology to keep packages safe for a duration until the particular customer is able to pick up the package(s). In one example embodiment, drop box 102 is equipped to handle one or more packages for different parties, each in a respective secured space within drop box 102. In another example embodiment, drop box 102 may be located in a hurricane area and receive a weather related Rich Site Summary (RSS) feed of an incoming hurricane. Drop box 102, using drop box software 116, may seal secure space 110 to protect the stored packages and inform customers and the retailer distribution center that the drop box will be sealed to prevent moisture from entering until the storm has passed. At that point the customers and retailer are notified that normal package drop-offs and pick-ups to drop box 102 may resume.

In step 212, drop box 102 performs package verification such as scanning bar codes, scanning an RFID tag, and measuring the package weight. For example, drop box software 116 uses camera 112 to capture and process an image of any barcodes on the package. The barcodes may then be verified with the retailer or distribution center. In one example embodiment, drop box 102 may use a RFID tag reader to gather describing information on the packages then verify them with retailers and distribution centers. Drop box 102 also uses scale 114 to measure the weight of the package being deposited by autonomous device 120. The measured weight of the package is then compared to the stored measured weight of the package when the package was weighed at the retailer or distribution center.

In decision step 214, drop box 102 determines if the package was verified. If the package was not verified (“No” branch, decision 214), drop box 102 rejects the package as depicted in step 216. Autonomous device 120 then removes the package from secure space 110, and drop box 102 returns to step 202. In one example embodiment, when a package fails verification and the autonomous device fails to remove the package, drop box 102 may isolate the package and go into lockdown and notify customers and retailers of the situation until the package can be properly examined. If the package was verified (“Yes” branch, decision 214), drop box 102 closes and locks the now occupied slot in secure space 110 and then secures the package with a passcode, also referred to as a password, as depicted in step 218. The passcode may be generated using any random password generator. A random password generator is software program or hardware device that takes input from a random or pseudo-random number generator and automatically generates a password. In one example embodiment, passwords may be assigned by a separate device located within package delivery environment 100.

In step 220, drop box 102 informs autonomous device 120 of the passcode and/or sends passcode to retailer and/or sends passcode to customer. The passcode is used by customers to retrieve the package(s) from secure space 110. The passcode may be transmitted using a text message, via an email, or placed in a database to be retrieved by the customers using a secure website. In another example embodiment, drop box 102 may be in communication with the delivery company and be able to confirm the arrival of the appropriate autonomous device and can also make use of RFID or barcode technology to ensure the package being deposited matches the one that was supposed to be delivered. In other example embodiments, instead of transmitting the passcode to the autonomous device, drop box 102 may transmit the passcode to the customer or to the retailer.

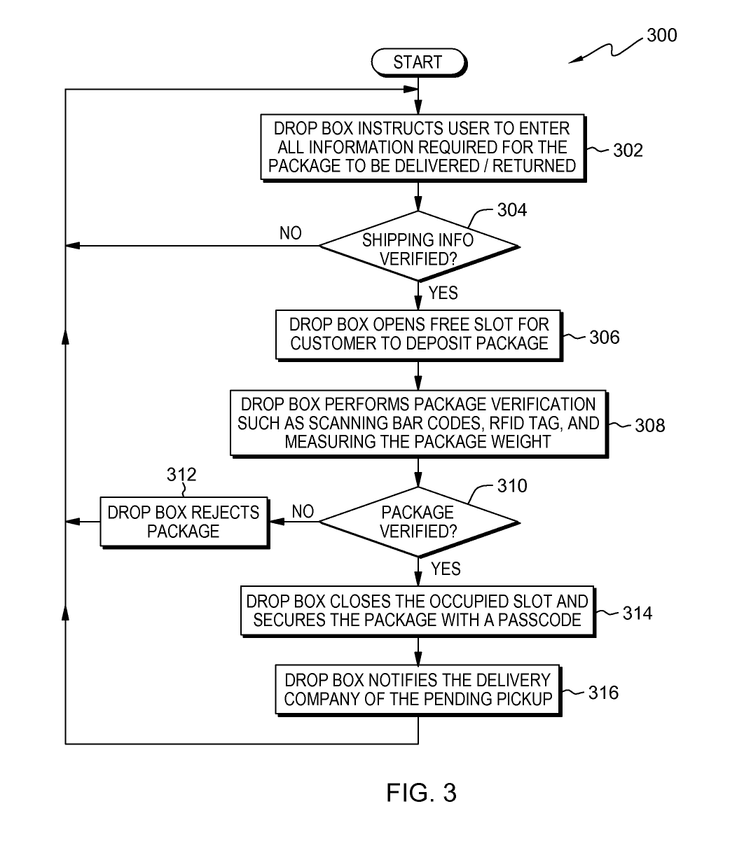

FIG. 3 is a flowchart, generally designated 300, depicting operational steps of drop box software, on a smart drop box within the package delivery environment of FIG. 1, for receiving a package from a customer to be picked up by an autonomous device, in an embodiment in accordance with the present invention. In this example embodiment, a customer is delivering a package to drop box 102 to be returned to the retailer. Drop box 102 and drop box software 116 instruct the user to enter all shipping information required for the package to be delivered or returned to the retailer as depicted in step 302. For example, the customer may be required to attach a return shipping label printed out at drop box 102. Upon printing the label, drop box software 116 may ask the user to input one or more of the following: (i) the name the order was placed under, (ii) an order number, (iii) a return address, (iv) a return merchandise authorization (RMA) number, and/or (v) a shipping address where the package is to be returned to. An RMA, also referred to as a return authorization (RA) or return goods authorization (RGA), is a part of a process of returning a product in order to receive a refund, replacement, or repair during a product's warranty period. To return a product, the purchaser must contact the retailer to obtain authorization to return the product. Generally speaking, the resulting RMA number must then be displayed on, or included in, the returned product's packaging.

In decision step 304, drop box 102 verifies all shipping information, also referred to as sending information, entered by the customer for the package. If the shipping information fails verification (“No” branch, decision 304), drop box 102 rejects the package and repeats step 302 as depicted in FIG. 3. If the shipping information is verified (“Yes” branch, decision 304), drop box 102 opens a free slot in secure space 110 so the customer may deposit the package as depicted in step 306. In another example embodiment, drop box 102, or the retailer, may provide a secure website where customers may enter the required shipping information from home or from a mobile device. Upon arriving at drop box 102, the customer may enter a reference number and is provided with a shipping label containing all the required information for the package.

Drop box 102 performs package verification such as scanning bar codes, RFID tags, and measuring the package weight as depicted in step 308. Drop box software 116 may use camera 112 to capture and process images of bar codes and may also use a RFID tag reader to gather information on the packages, and may use scale 114 to weigh the package then verify the gathered information with retailer and/or distribution center, also referred to as the autonomous device delivery provider.

In decision step 310, drop box software 116 determines if the package was verified by the retailer and/or distribution center. If the package is not verified (“No” branch, decision 310), drop box software 116 rejects the package as depicted in step 312, then instructs the customer to remove the package from secure space 110. Drop box 102 the repeats step 302 as depicted in FIG. 3. If the package is verified (“Yes” branch, decision 310), drop box software 116 closes the now occupied slot in secure space 110 and secures the package with a passcode required to open secure space 110 at a later time as depicted in step 314.

In step 316, drop box 102 and drop box software 116 notifies the delivery company of the pending pickup and an autonomous device is dispatched to deliver the package back to the retailer. For example, when the retailer receives one or more notifications of the package in drop box 102, the package information, such as the weight, barcode, RFID, and location, is transmitted to autonomous device 120. Autonomous device 120 may then leave a docking station and then travel to drop box 102. In other example embodiments, customers and the retailer or distribution center may receive updates in the form of text messages, website updates detailing autonomous device 120's checkpoints along the travel route, or via RSS feeds.

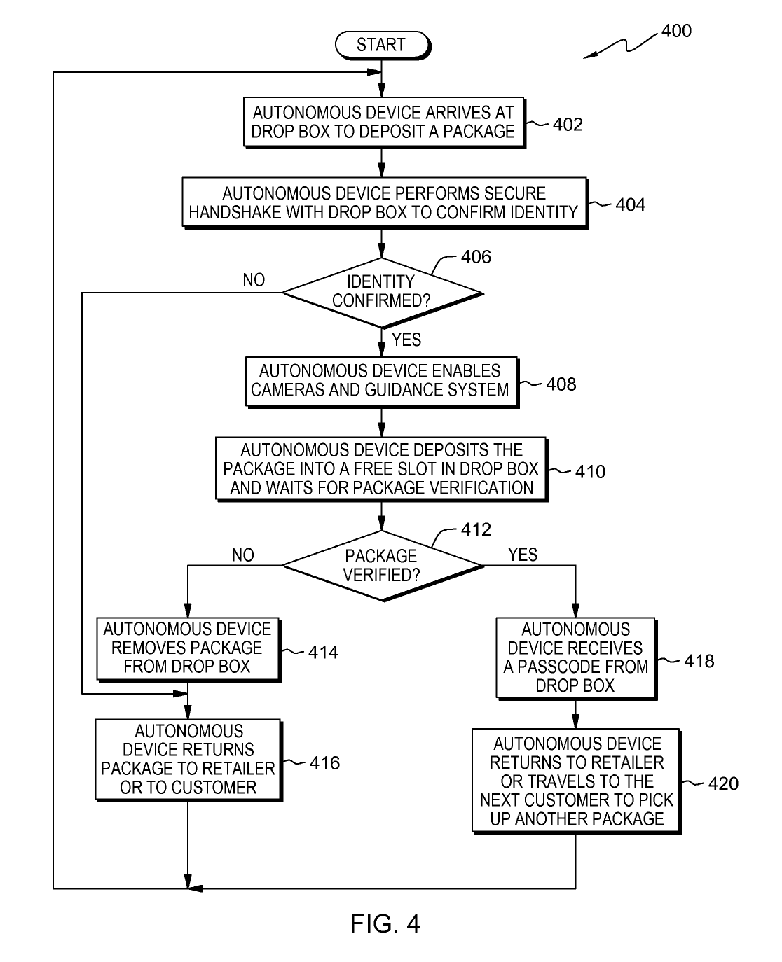

FIG. 4 is a flowchart, generally designated 400, depicting operational steps of an autonomous device, within the package delivery environment of FIG. 1, depositing a package in a smart drop box, in an embodiment in accordance with the present invention. In this example embodiment, autonomous device 120 arrives at drop box 102 to deposit a package as depicted in step 402. Autonomous device 120 may be delivering a package from a retailer or distribution center or from a customer home where the package could not be delivered. In some example embodiments, autonomous device 120 may travel to drop box 102 using the most efficient route to conserve power. In other example embodiments, autonomous device 120 may utilize charging stations at designated areas or on drop box 102, or utilize solar energy.

In step 404, autonomous device authenticates with drop box 102 by performing a secure handshake to confirm identities. The methods described above in relation to step 204 in FIG. 2 may be used to confirm identities.

In decision step 406, autonomous device determines if identities have been confirmed. If identities have not been confirmed (“No” branch, decision 406), autonomous device 120 returns the package to the retailer or distribution center, or to the customer as depicted in step 416 and may return to step 402. For example, autonomous device may return to the customers' house, set the package on the porch, and notify the customer of the failed delivery. If identities have been confirmed (“Yes” branch, decision 406), autonomous device 120 enables camera 128 and guidance systems (not shown) as depicted in step 408. A guidance system is a virtual or physical device, or a group of devices implementing a guidance process used for controlling the movement of a device, vehicle, ship, or aircraft by calculating the changes in position, velocity, attitude, and/or rotation rates of a moving object required to follow a certain trajectory and/or attitude profile based on information about the object's state of motion. In one example embodiment, the guidance systems may include camera 112 in drop box 102.

Autonomous device 120 deposits the package into a free slot in secure space 110 and waits for package verification as depicted in step 410. Package verification may include the procedures described above in relation to step 212 of FIG. 2. In some example embodiments, autonomous device may also transmit the package information to drop box software 116 to also be compared with the information received from the customer or distribution center. In other example embodiments, autonomous device 120 may first place the package in a verification area to wait for package verification. Upon the package being verified, autonomous device 120 may move the package to secure space 110, or return the package to the customer or distribution center.

In decision step 412, autonomous device 120 determines if the package was verified. Stated another way, autonomous device 120 determines if drop box 102 accepted the package with the supplied shipping information. If the package was not verified (“No” branch, decision 412), autonomous device 120 removes the package from secure space 110 as depicted in step 414. Autonomous device 120 then returns the package to the retailer or distribution center, or to the customer as depicted in step 416 and may return to step 402.

If the package was verified (“Yes” branch, decision 412), autonomous device 120 receives a passcode from drop box 102 to be relayed to the customer, retailer, or distribution center as depicted in step 418. In some example embodiments, drop box software 116 may transmit the passcode to the customer, retailer, or distribution center directly. In other example embodiments, drop box 102 may apply an RFID tag to the package once it has been verified and placed into secure space 110.

Autonomous device 120 then returns to the retailer, distribution center, or travels to the next customer to pick up another package as depicted in step 420. In another example embodiment, autonomous device 120 may receive instructions for the next delivery while docked at drop box 102.

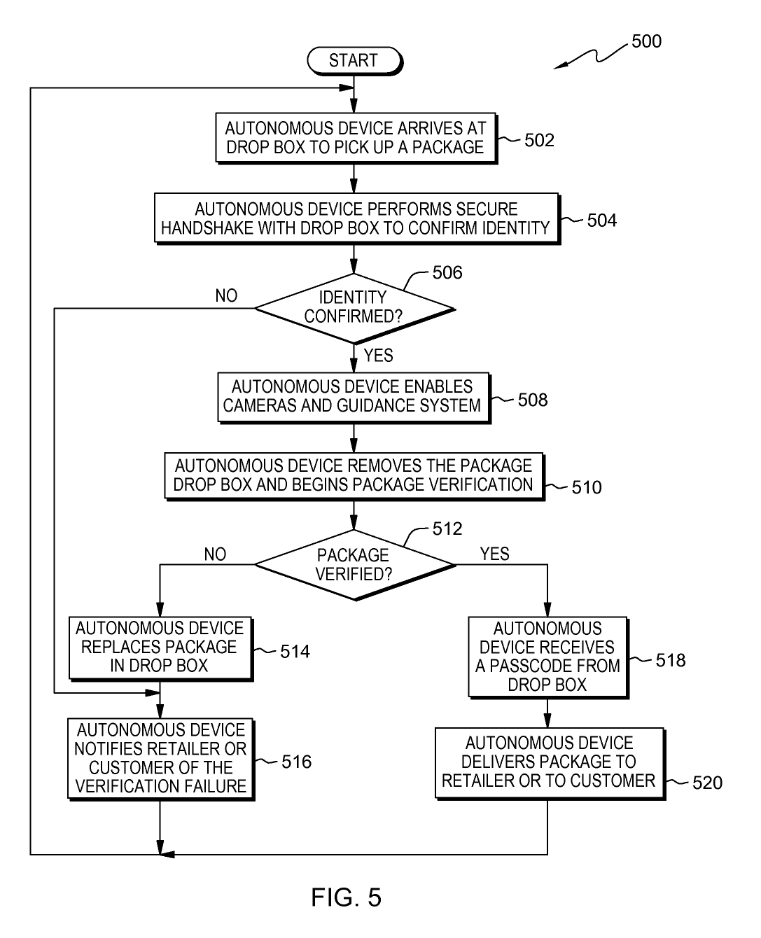

FIG. 5 is a flowchart, generally designated 500, depicting operational steps of an autonomous device, within the package delivery environment of FIG. 1, picking up a package from a smart drop box, in an embodiment in accordance with the present invention. In this example embodiment, autonomous device 120 arrives at drop box 102 to pick up a package as depicted in step 502. Information relating to the package may have been transmitted to autonomous device by a customer using a secure website, or by the retailer or distribution center via network 118. In another example embodiment, autonomous device 120 may receive instructions for a package pickup at drop box 102 by another autonomous device. In the event an autonomous device experiences technical issues, the autonomous device may detect and communicate with other nearby autonomous devices and relay the current package delivery information to be carried out by another autonomous device.

Upon approaching drop box 102, autonomous device authenticates with drop box 102 by performing a secure handshake to confirm identities, as depicted in step 504. The methods described above in relation to step 204 in FIG. 2 and step 404 in FIG. 4 may be used to confirm identities.

In decision step 506, autonomous device 120 determines if identities have been confirmed. If identities have not been confirmed (“No” branch, decision 506), autonomous device 120 notifies the retailer or distribution center, or to the customer of the verification failure as depicted in step 516 and may return to step 502. For example, autonomous device may notify the customer or distribution center the failed pick up and then return to the distribution center or wait at drop box 102 in a docking station until new package delivery instructions are received. If identities have been confirmed (“Yes” branch, decision 506), autonomous device 120 enables camera 128 and guidance systems (not shown) as depicted in step 508.

In step 510, autonomous device 120 removes the package from secure space 110 and begins package verification. For example, autonomous device may use camera 128 to capture and process an image of any barcodes on the package. The barcodes may then be verified with the retailer or distribution center. In another example embodiment, autonomous device 120 may use a RFID tag reader to gather information on the packages then verify them with retailers and distribution centers. Autonomous device 120 also uses scale 130 to measure the weight of the package. The measured weight of the package is then compared to the stored measured weight of the package when the package was weighed at the retailer or distribution center.

In decision step 512, autonomous device 120 determines if the package was verified. Stated another way, autonomous device 120 determines if the package matches with the supplied shipping information. If the package was not verified (“No” branch, decision 512), autonomous device 120 places the package back in secure space 110 as depicted in step 514. Autonomous device 120 then notifies the retailer or distribution center, or to the customer of the verification failure as depicted in step 516 and may repeat step 502.

If the package was verified (“Yes” branch, decision 512), autonomous device 120 receives a passcode from drop box 102 to be relayed to the customer, retailer, or distribution center as depicted in step 518. In one example embodiment, autonomous device 120 may notify a second intended recipient that a second package is incoming, wherein the notifying includes a security identifier needed to receive the second package. In some example embodiments, autonomous device 120 may transmit the passcode to the customer, retailer, or distribution center directly. In other example embodiments, autonomous device 120 may apply an RFID tag to the package once it has been verified and removed from secure space 110. In another example embodiment, autonomous device 120 may secure the package to prevent it from falling or possibly being removed from the autonomous device.

Autonomous device 120 then returns to the retailer, distribution center, or travels to the next customer to pick up another package as depicted in step 520. In another example embodiment, autonomous device 120 may receive instructions for the next delivery while picking up a package from drop box 102.

FIG. 6 depicts a block diagram, generally designated 600, of components of the smart drop box executing the drop box software, in an embodiment in accordance with the present invention. It should be appreciated that FIG. 6 provides only an illustration of one implementation and does not imply any limitations with regard to the environments in which different embodiments may be implemented. Many modifications to the depicted environment may be made.

Smart drop box 102 includes communications fabric 602, which provides communications between computer processor(s) 604, memory 406, persistent storage 608, communications unit 610, and input/output (I/O) interface(s) 412. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer readable storage media. In this embodiment, memory 606 includes random access memory (RAM) 614 and cache memory 616. In general, memory 606 can include any suitable volatile or non-volatile computer readable storage media.

Drop box software 116 is stored in persistent storage 608 for execution by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices, including resources of network 118 and autonomous device 120. In these examples, communications unit 610 includes one or more network interface cards. Communications unit 610 may provide communications through the use of either or both physical and wireless communications links. Drop box software 116 may be downloaded to persistent storage 608 through communications unit 610.

I/O interface(s) 612 allows for input and output of data with other devices that may be connected to drop box 102. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., drop box software 116, can be stored on such portable computer readable storage media and can be loaded onto persistent storage 608 via I/O interface(s) 612. I/O interface(s) 612 also connect to a display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for using a smart drop box, the method comprising:
determining, by one or more processors, whether an autonomous device is to perform one of a delivery to a smart drop box or a pickup from the smart drop box, wherein the smart drop box is equipped to handle one or more packages for different parties, each in a respective secured space within the smart drop box;
in response to a determination that the autonomous device is to perform delivery to the smart drop box, receiving, by one or more processors, a secure identification from the autonomous device upon approach to the smart drop box, including an indication of a first package for delivery;
determining, by one or more processors, whether a current weight of the first package is substantially equal to a weight of the first package when initially shipped;
in response to a determination that the current weight of the first package is substantially equal to the weight of the first package when initially shipped, allowing, by one or more processors, the first package to be transferred to the smart drop box, wherein the first package is secured; and
notifying, by one or more processors, a first intended recipient that the first package is awaiting pickup, wherein the notifying further comprises a security identifier needed to open the smart drop box.

2. The method of claim 1, further comprising:
in response to a determination that the autonomous device is to perform the pickup from the smart drop box, receiving, by one or more processors, information describing sending information associated with a customer including information required for a second package to be delivered;
receiving, by one or more processors, the secure identification from the autonomous device upon approach to the smart drop box;
determining, by one or more processors, whether a current weight of the second package is substantially equal to a weight of the second package indicated by an autonomous device delivery provider;
in response to a determination that the current weight of the second package is substantially equal to a weight of the second package indicated by the autonomous device delivery provider, allowing, by one or more processors, the second package to be delivered by the autonomous device to a second intended recipient; and
notifying, by one or more processors, the second intended recipient that the second package is incoming, wherein the notifying includes a security identifier needed to receive the second package.

3. The method of claim 1, wherein determining whether a current weight of the first package is substantially equal to a weight of the first package when initially shipped comprises:
determining, by one or more processors, whether the current weight of the first package and the weight of the first package when initially shipped are within a predefined delta based on the material used to enclose the first package.

4. The method of claim 1, wherein allowing the first package to be transferred to the smart drop box further comprises:
opening, by one or more processors, a secure space located within the smart drop box; and
activating, by one or more processors, one or more cameras within the smart drop box to record the transfer of the first package to the smart drop box.

5. The method of claim 1, wherein securing the first package comprises:
upon the smart drop box receiving the first package, closing, by one or more processors, the secure space;
locking, by one or more processors, the secure space; and
generating, by one or more processors, the security identifier, wherein the security identifier is used to open the secure space at a later time.

6. The method of claim 2, wherein the information describing sending information includes at least one of the following:
a name the order was placed under,
an order number,
a return address,
a return merchandise authorization (RMA) number, and
a shipping address where the second package is to be delivered to.

7. The method of claim 1, wherein notifying a first intended recipient further comprises:
sending, by one or more processors, one or more notifications to the first intended recipient using at least one of the following:
a text message,
one or more website updates detailing checkpoints along a travel route, and
a Rich Site Summary (RSS) feed.

8. A computer program product for using a smart drop box, the computer program product comprising:
one or more computer readable storage media and program instructions stored on the one or more computer readable storage media, the program instructions comprising:
program instructions to determine whether an autonomous device is to perform one of a delivery to a smart drop box or a pickup from the smart drop box, wherein the smart drop box is equipped to handle one or more packages for different parties, each in a respective secured space within the smart drop box;
program instructions to, in response to a determination that the autonomous device is to perform delivery to the smart drop box, receive a secure identification from the autonomous device upon approach to the smart drop box, including an indication of a first package for delivery;
program instructions to determine whether a current weight of the first package is substantially equal to a weight of the first package when initially shipped;
program instructions to, in response to a determination that the current weight of the first package is substantially equal to the weight of the first package when initially shipped, allow the first package to be transferred to the smart drop box, wherein the first package is secured; and
program instructions to notify a first intended recipient that the first package is awaiting pickup, wherein the notifying further comprises a security identifier needed to open the smart drop box.

9. The computer program product of claim 8, further comprising:
program instructions to, in response to a determination that the autonomous device is to perform the pickup from the smart drop box, receive information describing sending information associated with a customer including information required for a second package to be delivered;
program instructions to receive the secure identification from the autonomous device upon approach to the smart drop box;
program instructions to determine whether a current weight of the second package is substantially equal to a weight of the second package indicated by an autonomous device delivery provider;
program instructions to, in response to a determination that the current weight of the second package is substantially equal to a weight of the second package indicated by the autonomous device delivery provider, allow the second package to be delivered by the autonomous device to a second intended recipient; and
program instructions to notify the second intended recipient that the second package is incoming, wherein the notifying includes a security identifier needed to receive the second package.

10. The computer program product of claim 8, wherein program instructions to determine whether a current weight of the first package is substantially equal to a weight of the first package when initially shipped comprise:
program instructions to determine whether the current weight of the first package and the weight of the first package when initially shipped are within a predefined delta based on the material used to enclose the first package.

11. The computer program product of claim 8, wherein program instructions to allow the first package to be transferred to the smart drop box further comprise:
program instructions to open a secure space located within the smart drop box; and
program instructions to activate one or more cameras within the smart drop box to record the transfer of the first package to the smart drop box.

12. The computer program product of claim 8, wherein program instructions to secure the first package further comprise:
program instructions to, upon the smart drop box receiving the first package, close the secure space;
program instructions to lock the secure space; and
program instructions to generate a security identifier, wherein the security identifier is used to open the secure space at a later time.

13. The computer program product of claim 9, wherein the information describing sending information includes at least one of the following:
a name the order was placed under,
an order number,
a return address,
a return merchandise authorization (RMA) number,
a shipping address where the second package is to be delivered to.

14. The computer program product of claim 8, wherein notifying an intended recipient further comprises:
program instructions to send one or more notifications to the intended recipient in at least one of the following ways:
a text message,
one or more website updates detailing checkpoints along a travel route,
a Rich Site Summary (RSS) feed.

15. A computer system for using a smart drop box, the computer system comprising:
one or more computer processors;
one or more computer readable storage media;
program instructions stored on the computer readable storage media for execution by at least one of the one or more processors, the program instructions comprising:
program instructions to determine whether an autonomous device is to perform one of a delivery to a smart drop box or a pickup from the smart drop box, wherein the smart drop box is equipped to handle one or more packages for different parties, each in a respective secured space within the smart drop box;
program instructions to, in response to a determination that the autonomous device is to perform delivery to the smart drop box, receive a secure identification from the autonomous device upon approach to the smart drop box, including an indication of a first package for delivery;
program instructions to determine whether a current weight of the first package is substantially equal to a weight of the first package when initially shipped;
program instructions to, in response to a determination that the current weight of the first package is substantially equal to the weight of the first package when initially shipped, allow the first package to be transferred to the smart drop box, wherein the first package is secured; and
program instructions to notify a first intended recipient that the first package is awaiting pickup, wherein the notifying further comprises a security identifier needed to open the smart drop box.

16. The computer system of claim 15, further comprising:
program instructions to, in response to a determination that the autonomous device is to perform the pickup from the smart drop box, receive information describing sending information associated with a customer including information required for a second package to be delivered;
program instructions to receive the secure identification from the autonomous device upon approach to the smart drop box;
program instructions to determine whether a current weight of the second package is substantially equal to a weight of the second package indicated by an autonomous device delivery provider;
program instructions to, in response to a determination that the current weight of the second package is substantially equal to a weight of the second package indicated by the autonomous device delivery provider, allow the second package to be delivered by the autonomous device to a second intended recipient; and
program instructions to notify the second intended recipient that the second package is incoming, wherein the notifying includes a security identifier needed to receive the second package.

17. The computer system of claim 15, wherein program instructions to determine whether a current weight of the first package is substantially equal to a weight of the first package when initially shipped comprise:
program instructions to determine whether the current weight of the first package and the weight of the first package when initially shipped are within a predefined delta based on the material used to enclose the first package.

18. The computer system of claim 15, wherein program instructions to allow the first package to be transferred to the smart drop box further comprise:
program instructions to open a secure space located within the smart drop box; and
program instructions to activate one or more cameras within the smart drop box to record the transfer of the first package to the smart drop box.

19. The computer system of claim 15, wherein program instructions to secure the first package further comprise:
program instructions to, upon the smart drop box receiving the first package, close the secure space;
program instructions to lock the secure space; and
program instructions to generate a security identifier, wherein the security identifier is used to open the secure space at a later time.

20. The computer system of claim 16, wherein the information describing sending information includes at least one of the following:
a name the order was placed under,
an order number,
a return address,
a return merchandise authorization (RMA) number,
a shipping address where the second package is to be delivered to.
